(19) United States
(12) Patent Application Publication
(10) Pub. No.: US 2025/0318529 A1
(43) Pub. Date: Oct. 16, 2025

(54) METHOD FOR MOSQUITO CONTROL

(71) Applicant: SYNGENTA CROP PROTECTION AG, Basel (CH)

(72) Inventors: Mark HOPPE, Stein (CH); Lisa EPPLER, Basel (CH)

(73) Assignee: SYNGENTA CROP PROTECTION AG, Basel (CH)

(21) Appl. No.: 18/866,340

(22) PCT Filed: May 16, 2023
(86) PCT No.: PCT/EP2023/063174

§ 371 Date: Nov. 15, 2024

(30) Foreign Application Priority Data
May 16, 2022 (EP) 22173625.9

(51) Int. Cl. A01N 43/80; A01N 25/10; A01N 25/34; A01P 7/04

(52) U.S. Cl. CPC A01N 43/80; A01N 25/10; A01N 25/34; A01P 7/04

(57) ABSTRACT

The present inventions concerns use of isocycloseram to control mosquitoes including mosquito vectors of pathogenic disease and mosquitoes having developed insecticide resistance, such as pyrethroid insecticide resistance.

The present invention is in the technical field of mosquito control with a certain isooxazoline compound. More specifically, the present invention relates to methods of controlling mosquitoes including mosquito vectors of pathogenic disease and mosquitoes having developed insecticide resistance, such as against pyrethroids, each comprising a mosquitocidally active isooxazoline compound.

Mosquito control manages the population of mosquitoes to reduce their damage to human health, economies, and enjoyment. Mosquito control is a vital public-health practice throughout the world and especially in the tropics because mosquitoes spread many diseases, such as malaria (Wikipedia contributors, “Mosquito control”, Wikipedia).

Many infectious diseases (e.g. malaria, dengue and yellow fever, lymphatic filariasis, and leishmaniasis) that are responsible for debilitating or even killing humans and animals in many countries, especially in tropical countries, are transmitted by insect vectors. For example, the mosquito parasite, Plasmodium falciparum, accounts for greater than 25 percent of childhood mortality outside the neonatal period. In certain parts of Africa, malaria has been ranked first by the World Bank in terms of disability-adjusted life-years lost. A number of drugs are available to treat and/or prevent some insect-borne diseases. However, not all diseases transmitted by mosquitoes can be treated efficiently. For example, there is currently no chemotherapeutic drug or vaccine available against the Dengue virus. Furthermore, in the case of antimalarial drugs, treatment with the drugs currently available is becoming less effective due to increased resistance in some Plasmodium strains. Plasmodium enters the human bloodstream as a consequence of the insect bite and causes malaria. Therefore, one of the most effective ways to prevent mosquito vector-borne illnesses is by decreasing mosquito populations in areas of high pathogen transmission and/or preventing mosquito bites in the first place. More recently, efforts have been concentrated on controlling the transmitting mosquitoes.

The three medically important genera of insects which transmit diseases are the mosquitoes Anopheles, Culex and Aedes. The genera Culex and Aedes belong to the sub-family Culicinae, while the Anopheles belongs to the sub-family Anophelinae. Examples of diseases or pathogens transferred by the key mosquitoes are: Anopheles: malaria, filariasis; Culex: Japanese encephalitis, other viral diseases, filariasis; and Aedes: yellow fever, dengue fever, chikungunya, other viral diseases (e.g Zika virus), and filariasis.

In an attempt to reduce the problems associated with disease-transmitting mosquitoes, a wide range of insecticides and insect repellents have been developed. Mosquitoes can be targeted with insecticides when they are in a larval state or once they have developed into adults. Accordingly, insecticides which are used to kill larvae are termed larvicides whereas insecticides that are used to specifically target adult insects are called adulticides. Most of the insecticides commonly used to prevent the spread of disease are targeted against the adult mosquito and in particular against the female adult mosquito.

The organochlorine DDT was the most widespread compound used worldwide as an adulticide until it was withdrawn from use in most areas. After that, organophosphates such as malathion, carbamates and propoxur were widely used in vector control programmes in most parts of the world and were steadily replaced by pyrethroids, which became the mostly used adulticide, Organophosphates, such as pirimiphos-methyl are now being used again due to the development of pyrethroid resistance in many important vector species.

One of the most important problems associated with pyrethroids, like their predecessors, is that resistance has already developed in many insect species in several parts of the world. Pyrethroid resistance, caused either by specific detoxification enzymes or an altered target site mechanism (kdr-type mutations in the sodium channels), has been reported in most continents in the majority of medically important mosquitoes species, such as Anopheles gambiae in Africa and Aedes aegypti in Asia. If resistance continues to develop and spread at the current rate, it may render such insecticides ineffective in their current form in the not too distant future. Such a scenario would have potentially devastating consequences in public health terms, since there are as yet no obvious alternatives to many of the uses of pyrethroids.

Therefore, there is an ongoing search for insecticides for control of mosquitoes, especially for mosquitoes having developed resistance, such as against pyrethroids.

Certain isoxazoline derivatives with insecticidal properties are disclosed, for example, in WO2011/067272. One specific isoxazoline with insecticidal properties is isocycloseram.

Isocycloseram is an insecticidal agrochemical with the following CAS number: 2061933-85-3, and is represented by chemical formula (I):

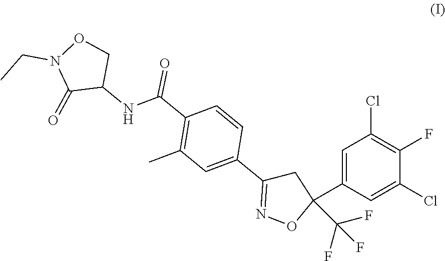 [SMILES: CCN1OCC(NC(=O)c2ccc(C3=NOC(c4cc(Cl)c(F)c(Cl)c4)(C(F)(F)F)C3)cc2C)C1=O]

Isocycloseram can comprise the isomer (5S,4R) which is 4-[(5S)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide (CAS no. 1309959-62-3), and optionally at least one of the isomers selected among isomer (5S,4S), isomer (5R,4R), isomer (5R,4S), and any combinations thereof. In the present invention, the isomer (5S,4S) is 4-[(5S)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide; the isomer (5R,4R) is 4-[(5R)-5-(3,5-dichloro-4-fluoro-phenyl)-5-(trifluoromethyl)-4H-isoxazol-3-yl]-N-[(4R)-2-ethyl-3-oxo-isoxazolidin-4-yl]-2-methyl-benzamide; and the isomer (5R,4S) is 4-[(5R)-5-(3,5-dichloro-4-fluoro-phenyl)-5-(trifluoromethyl)-4H-isoxazol-3-yl]-N-[(4S)-2-ethyl-3-oxo-isoxazolidin-4-yl]-2-methyl-benzamide. When isocycloseram further comprises at least one of the isomers selected among isomer (5S,4S), isomer (5R,4R), isomer (5R,4S), and any combinations thereof, isocycloseram can comprise a molar proportion of the isomer (5S,4R) greater than 50%, e.g. at least 55%, 60%, 65%, 70%, 75%, 80%, 85%, 90%, 95%, 96%, 97%, 98% or 99%, over the total amount of the isomers (5S,4R), (5S,4S), (5R,4R) and (5R,4S).

It has now been found that isocycloseram is particularly suitable for mosquitoes including mosquito vectors of pathogenic disease and mosquitoes having resistance to insecticides such as pyrethroids.

Therefore, the present invention provides a method for controlling nuisance, disease carrying or pyrethroid resistant mosquito pests comprising applying mosquitocidally effective amount of isocycloseram to such mosquito pest or to a locus where such control is desired.

As well as the biological efficacy of isocycloseram against mosquitos and resistant strains of such mosquitos, other embodiments of the present invention include its safety (such as its toxicity, persistence) to the environment, including to the users of a vector control solution; its suitability for making a vector control solution product (whether indoor residual spray formulation, mosquito net, or another type), its suitability for adherence and availability on a surface over a period of time (in the event the solution is an indoor residual spray), and also its suitability for incorporation into a polymer product (such as a net) so that the compound would be readily available to control mosquitos on the surface of the net over a period of time and the nets can withstand multiple washings.

In one embodiment, a method for controlling nuisance, disease carrying or insecticide resistant mosquito pests, in particular pyrethroid insecticide resistant mosquito pests, according to the invention includes a method to control, limit or eradicate mosquito pests which transmit disease pathogens.

In one embodiment, isocycloseram in accordance with the methods and other aspects of the present invention is useful in controlling mosquitoes, in particular mosquitoes that are vectors of or transmit disease pathogens, more particularly mosquitoes that are insecticide resistant including pyrethroid insecticide resistant, selected from the genus Anopheles, Culex and Aedes. Examples include Aedes aegypti, Aedes albopictus, Aedes japonicas, Aedes vexans, Coquillettidia perturbans, Culex molestus, Culex pallens, Culex pipiens, Culex quinquefasciatus, Culex restuans, Culex tarsalis, Anopheles albimanus, Anopheles albitarsis, Anopheles annularis, Anopheles aquasalis, Anopheles arabiensis, Anopheles aconitus, Anopheles atroparvus, Anopheles balabacensis, Anopheles coluzzii, Anopheles culicifacies, Anopheles darlingi, Anopheles dirus, Anopheles farauti, Anopheles flavirostris, Anopheles fluviatilis, Anopheles freeborni, Anopheles funestus, Anopheles gambiae s.l., Anopheles koliensis, Anopheles labranchiae, Anopheles lesteri, Anopheles leucosphyrus, Anopheles maculatus, Anopheles marajoara, Anopheles melas, Anopheles merus, Anopheles messeae, Anopheles minimus, Anopheles moucheti, Anopheles nili, Anopheles nuneztovari, Anopheles plumbeus, Anopheles pseudopunctipennis, Anopheles punctipennis, Anopheles punctulatus, Anopheles quadrimaculatus, Anopheles sacharovi, Anopheles sergentii, Anopheles sinensis, Anopheles stephensi, Anopheles subpictus, Anopheles sundaicus, Anopheles superpictus, and Mansonia titillans, Ochlerotatus stimulans, Ochlerotatus japonicas (each of which is an example of a mosquito capable of carrying or vectoring a pathogenic disease).

By control is meant that isocycloseram is employed in a manner that kills or repels the mosquito such that biting does not occur or in a manner that decreases mosquito populations such that biting does not occur as frequently or in a manner that inhibits the target mosquito from taking a blood meal.

In another embodiment, isocycloseram is useful in controlling one or more mosquitos selected from the genus Anopheles, Culex and Aedes, in particular one or more of Aedes aegypti, Aedes albopictus, Aedes japonicas, Aedes vexans, Culex molestus, Culex pallens, Culex pipiens, Culex quinquefasciatus, Culex restuans, Culex tarsalis, Anopheles albimanus, Anopheles arabiensis, Anopheles coluzzii, Anopheles darlingi, Anopheles dirus, Anopheles funestus, Anopheles gambiae s.l., Anopheles gambiae s.s. (Ifakara Strain), An. gambiae Tiassale; An. gambiae Kisumu, An. gambiae KisKDR, An. gambiae M'Bé, Anopheles melas, Anopheles minimus, Anopheles sinensis, Anopheles stephensi, Mansonia titillans.

In another embodiment, isocycloseram is useful in the methods and other aspects of the invention to control adult mosquitoes.

Insecticide resistant mosquito species have also been detected and accordingly in another embodiment, isocycloseram is suitable for controlling insecticide-resistant mosquitoes, such as pyrethroid and/or carbamate-resistant mosquitoes.

Pyrethroids are the only insectides that have obtained WHO recommendation against Malaria vectors on both Indoor Residuals Sprays (IRS) and Long Lasting Insecticidal Mosquito Nets (LLINs), in the form of Alpha-Cypermethrin, Bifenthrin, Cyfluthrin, Permethrin, Deltamethrin, Lambda-Cyhalothrin and Etofenprox. It has been the chemical class of choice in agriculture and public health applications over the last several decades because of its relatively low toxicity to humans, rapid knock-down effect, relative longevity (duration of 3-6 months when used as IRS), and low cost. However, massive use of pyrethroids in agricultural applications and for vector control led to the development of resistance in major malaria and dengue vectors. Strong resistance has e.g. been reported for the pyrethroid Deltamethrin (and Permethrin) for the Anopheles gambiae Tiassalé (from southern Cote d'Ivoire) strain (Constant V. A. Edi et al., Emerging Infectious Diseases; Vol. 18, No. 9, September 2012). Pyrethroid resistance was also reported for Permethrin, Deltamethrin and Lambda-Cyhalothrin for the Aedes aegypti Cayman Island strain (Angela F. Harris et al., Am. J. Trop. Med. Hyg., 83 (2), 2010) and Alpha-Cypermethrin, Permethrin and Lambda-Cyhalothrin for certain Anopheles strains (Win Van Bortel, Malaria Journal, 2008, 7:102).

In another embodiment of the invention, isocycloseram is suitable for use against insecticide-resistant mosquitoes that are selected from Anopheles gambiae RSPH, Anopheles gambiae Tiassale, Anopheles gambiae Akron, Anopheles gambiae Kisumi Rdl, Anopheles arabiensis NDjamina, Anopheles coluzzii VK7, Anopheles funestus FUMOZ, Aedes aegypti Grand Cayman, Culex quinquefasciatus strain POO and highly pyrethroid resistant Anopheles arabiensis (Kingani Strain).

In another embodiment, the methods of the invention are useful against the resistant mosquitoes such as those listed below:

Anopheles gambiae, strain RSPH is a multi-resistant mosquito (target-site and metabolic-resistance) that is described in the reagent catalog of the Malaria Research and Reference Reagent Resource Center (www.MR4.org; MR4-number: MRA-334).

Anopheles gambiae, strain Tiassalé is a multi-resistant mosquito (target and metabolic-resistant strain) which shows cross-resistance between carbamates, organophosphates and pyrethroids and is described in Constant V. A. Edi et al., Emerging Infectious Diseases; Vol. 18, No. 9, September 2012 and Ludovic P Ahoua Alou et al., Malaria Journal 9:167, 2010).

Anopheles gambiae, strain Akron is a multi-resistant mosquito (target and metabolic-resistant strain) and is described in Djouaka F Rousseau et al., BMC Genomics, 9:538; 2008.

Anopheles coluzzii, strain VK7 is a target-resistant mosquito and is described in Dabire Roch Kounbobr et al., Malaria Journal, 7:188, 2008.

Anopheles funestus, strain FUMOZ is a metabolic-resistant strain and is described in Hunt et al., Med Vet Entomol. 2005 Sep; 19 (3): 271-5). In this article it has been reported that Anopheles funestus—as one of the major malaria vector mosquitoes in Africa-showed resistance to pyrethroids and carbamate insecticides in South Africa.

Anopheles arabiensis (Kingani Strain) originating from Ifakara and in colony at Bagamoyo (a highly pyrethroid resistant strain).

Anopheles gambiae, strain Kisumi Rdl, a dieldrin resistant strain from Kenya.

Anopheles arabiensis, strain NDjamina, a pyrethroid resistant from Chad.

Aedes aegypti, strain Grand Cayman is a target-resistant mosquito and is described in Angela F. Harris, Am. J. Tro. Med. Hyg. 83 (2), 2010.

Culex quinquefasciatus (metabolic-resistant to DDT strain P00); received from Texchem, Penang, Malaysia.

Anopheles gambiae s.s population from M'Bé: Koffi, A. A., Ahoua Alou, L. P., Adja, M. A. et al. Insecticide resistance status of Anopheles gambiae s.s population from M'Bé: a WHOPES-labelled experimental hut station, 10 years after the political crisis in Côte d'Ivoire. Malar J 12, 151 (2013).

Vector control solution are means to control a vector, such as a mosquito. Examples of such means are compositions, products, and treated articles, which include a substrate or non-living material incorporating (e.g. coated or impregnated with) isocycloseram, spray products (e.g. indoor residual sprays, and aerosol products) comprising isocycloseram, paint compositions comprising isocycloseram, and products or treated articles comprising isocycloseram.

Examples of integrated mosquito vector management or control solutions of the invention, such as solutions for controlling mosquito bites, blood feeding or decreasing relevant mosquito populations, include the use of such compositions, products, treated articles and substrates of the invention at a locus of potential or known interaction between the mosquito vector and an animal, including a human, that is susceptible to a pathogenic disease infection transmitted by such vector. Suitable integrated solutions within the scope of the present invention also include identifying mosquito breeding sites and positioning compositions, products, treated articles and substrates of the invention at such sites.

Examples of a substrate or non-living material of the invention are self-supporting film/sheet (e.g., screens), threads, fibres, yarns, pellets, weaves (or textiles (e.g. for clothing)), nets, tents, and curtains incorporating (e.g. coated or impregnated with) isocycloseram, which can be used to protect against mosquito bites and reduce blood feeding. In particular, it is well known that humans can be protected in their sleep from mosquito stings by insecticidally coated sleeping nets. Coated or impregnated weaves of the invention can also be used as curtains in front of windows, doors open eaves, or ventilation openings, in order to control mosquito entering dwellings.

The use of a compound in a substrate of the present invention (e.g. nets and weaves) achieves at least one of the following objects:
good insecticidal effect
fast-acting insecticidal efficacy
long-lasting insecticidal efficacy
uniform release of active ingredient
long durability (including resisting multiple washings over an extended period)
simple production
safe to the user

The nets and weaves (or textiles) of the invention that incorporate (e.g. are coated or impregnated with) isocycloseram, are made up of a variety of natural and synthetic fibres, also as textile blends in woven or non-woven form, as knit goods or fibres. Natural fibres are for example cotton, raffia, jute, flax, sisal, hessian, wool, silk or hemp. Synthetic fibres may be made of polyamides, polyesters, polyacrylonitriles, polyolefines, for example polypropylene or polyethylene, Teflon, and mixtures of fibres, for example mixtures of synthetic and natural fibres. Polyamides, polyolefins and polyesters are preferred as fibre material. Polyester, such a polyethylene terephthalate, are especially preferred. Most preferred are nettings made from polyethylene and/or polypropylene.

The art discloses methods suitable for incorporating (by way of coating) a compound onto nets and weaves (see for example, WO2003/034823, WO 2008/122287, WO 01/37662, US2009036547, WO 2007/036710), from dipping or submerging them into a formulation of the insecticide or by spraying the formulation onto their surfaces. After treating the nets and weaves of the invention, they may be dried simply at ambient temperatures (see also below for more background). Such methods are also suitable for incorporating (by way of coating) isocycloseram.

Also disclosed in the art are methods suitable for incorporating by way of impregnating a compound within the net or weave by making polymer material in the presence of the isocycloseram, which is then extruded into fibres, threads or yarns, for making the nets and weaves (see for example, WO08004711, WO2009/121580, WO2011/128380, WO2011/141260, WO2010/118743). Such nets and weaves having available at the surface of the net and weave an effective amount of the compound so as to control mosquito bites. Generally the compound is mixed with the molten polymer. Such methods are also suitable for incorporating (by way of impregnating) isocycloseram.

The term “incorporating” or “incorporated” in context of the compound of the invention, additives and other insecticides is meant that the substrate or non-living material comprises or contains the respectively defined compound, additive and/or insecticide, such as by coating or impregnation.

Preferably the substrate of the present invention is a net, which net is preferably a long lasting net, incorporated with isocycloseram of by way of coating the net with a composition comprising isocycloseram, or by way of making a polymeric material in the presence of such isocycloseram and then processing the resultant polymeric material into an inventive net.

In accordance with the invention, when isocycloseram is used within the polymer, then during use of the resulting net or weave made from the polymer, such isocycloseram is released to the surface of the net to control against mosquito bites-such control is sustained at adequate level and for adequate amount of time.

Examples of suitable polymers are polyamides, polyesters, polyacrylonitriles, polyolefines, such as polyethylene compositions that can be made from different polyethylene polymers; these may be LDPE, LLDPE, MDPE and HDPE. LLDPE (Linear low-density polyethylene) is a substantially linear polymer (polyethylene), with significant numbers of short branches, commonly made by copolymerization of ethylene with longer-chain olefins. MDPE is medium-density polyethylene is a substantially linear polymer of polyethylene with shorter chain length than HDPE. HDPE (High-Density PolyEthylene) or PolyEthylene High-Density (PEHD) is a polyethylene thermoplast. HDPE has little branching, giving it stronger intermolecular forces and tensile strength than lower-density polyethylene. It is also harder and more opaque and can withstand somewhat higher temperatures (120 degrees C.I 248 degrees Fahrenheit for short periods, 110 degrees centigrade/230 degrees Fahrenheit continuously). HDPE yarns are stronger than LDPE mixed polyethylene yarns. LLDPE differs structurally from conventional low-density polyethylene (LDPE) because of the absence of long chain branching. These polyethylene compositions (HDPE, LDPE, LLDPE and mixture thereof) are generally used for preparing yarns and polyethylene based textile products. Methods for incorporating an insecticide compound into the polymer without weakening its resulting properties are known in the art, such as using mixtures of HDPE and LDPE. Such methods can also be used to incorporate isocycloseram into a polymer.

Examples of spray products of the present invention are indoor residual sprays or space sprays comprising isocycloseram. Indoor Residual Spraying (IRS) is the technique of applying a residual deposit of an insecticide onto indoor surfaces where vectors rest, such as on walls and ceilings. The primary goal of indoor residual spraying is to reduce the lifespan of the mosquito vectors and thereby reduce or interrupt disease transmission. The secondary impact is to reduce the density of mosquitos within the treatment area. IRS is a recognised, proven and cost-effective intervention method for the control of malaria and it is also used in the management of Leishmaniasis and Chagas disease. Many malaria mosquito vectors are endophilic, resting inside houses after taking a blood meal. These mosquitoes are particularly susceptible to control through indoor residual spraying (IRS) comprising isocycloseram. As its name implies, IRS involves coating the walls and other surfaces of a house with a residual insecticide. For several months, the isocycloseram will kill mosquitoes that come in contact with these surfaces. IRS does not directly prevent people from being bitten by mosquitoes. Rather, it usually kills mosquitoes after they have fed, if they come to rest on the sprayed surface. IRS thus prevents transmission of infection to other persons. To be effective, IRS must be applied to a very high proportion of households in an area (usually greater than 70 percent). Although the community plays a passive role in IRS programs, cooperation with an IRS effort is a key to its success. Community participation for IRS often consists of cooperating with the spray teams by removing food and covering surfaces prior to spraying and refraining from covering the treated surfaces with new paint or plaster. However, community or individual householder opposition to IRS due to the smell, mess, possible chemical exposure, or sheer bother has become a serious problem in some areas. Therefore, sprays in accordance with the invention having good residual efficacy and acceptable odour are particularly suited as a component of integrated mosquito vector management or control solutions.

In contrast to IRS, which requires that the active isocycloseram is bound to surfaces of dwellings, such as walls, ceiling, space spray products of the invention rely on the production of a large number of small insecticidal droplets intended to be distributed through a volume of air over a given period of time. When these droplets impact on a target mosquito, they deliver a lethal dose of the isocycloseram. The traditional methods for generating a space-spray include thermal fogging (whereby a dense cloud of insecticide droplets is produced giving the appearance of a thick fog) and Ultra Low Volume (ULV), whereby droplets are produced by a cold, mechanical aerosol-generating machine.

Since large areas can be treated at any one time this method is a very effective way to rapidly reduce the population of flying mosquitoes in a specific area. Since there is very limited residual activity from the application it must be repeated at intervals of 5-7 days in order to be fully effective. This method can be particularly effective in epidemic situations where rapid reduction in mosquito numbers is required. As such, it can be used in urban dengue control campaigns.

Effective space-spraying is generally dependent upon the following specific principles:
Target insects are usually flying through the spray cloud (or are sometimes impacted whilst resting on exposed surfaces). The efficiency of contact between the spray droplets and target insects is therefore crucial. This is achieved by ensuring that spray droplets remain airborne for the optimum period of time and that they contain the right dose of insecticide. These two issues are largely addressed through optimizing the droplet size.
If droplets are too big they drop to the ground too quickly and don't penetrate vegetation or other obstacles encountered during application (limiting the effective area of application). If one of these big droplets impacts an individual insect then it is also ‘overkill’ since a high dose will be delivered per individual insect.
If droplets are too small then they may either not deposit on a target insect (no impaction) due to aerodynamics or they can be carried upwards into the atmosphere by convection currents.
The optimum size of droplets for space-spray application are droplets with a Volume Median Diameter (VMD) of 10-25 microns.

The compositions of the present invention may be made available in a spray product as an aerosol-based application, including aerosolized foam applications. Pressurised cans are the typical vehicle for the formation of aerosols. An aerosol propellant that is compatible with the insecticide compound is used. Preferably, a liquefied-gas type propellant is used. Suitable propellants include compressed air, carbon dioxide, butane and nitrogen. The concentration of the propellant in the isocycloseram composition is from about 5 percent to about 40 percent by weight of the isocycloseram composition, preferably from about 15 percent to about 30 percent by weight of the isocycloseram composition.

In one embodiment, the isocycloseram formulation of the invention can also include one or more foaming agents. Foaming agents that can be used include sodium laureth sulphate, cocamide DEA, and cocamidopropyl betaine. Preferably, the sodium laureth sulphate, cocamide DEA and cocamidopropyl are used in combination. The concentration of the foaming agent(s) in the isocycloseram composition is from about 10 percent to about 25 percent by weight, more preferably 15 percent to 20 percent by weight of the composition.

When the isocycloseram formulation is used in an aerosol application not containing foaming agents), the composition of the present invention can be used without the need for mixing directly prior to use. However, aerosol formulations containing the foaming agents do require mixing (i.e. shaking) immediately prior to use. In addition, if the formulations containing foaming agents are used for an extended time, they may require additional mixing at periodic intervals during use.

A dwelling area may also be treated with the isocycloseram composition of the present invention by using a burning formulation, such as a candle, a smoke coil or a piece of incense containing the composition. For example, composition may be comprised in household products such as “heated” air fresheners in which insecticidal compositions are released upon heating, for example, electrically, or by burning.

The compositions used in the method of the present invention containing isocycloseram may be made available in a spray product as an aerosol, a mosquito coil, and/or a vaporiser or fogger.

The concentration of the isocycloseram in the polymeric material, fibre, yarn, weave, net, or substrate, each of the invention, can be varied within a relatively wide concentration range from, for example 0.05 to 15 percent by weight, preferably 0.2 to 10 percent by weight, more preferably 0.4 to 8 percent by weight, especially 0.5 to 5, such as 1 to 3, percent by weight.

The percentages mentioned above are based on dry weight of the net or substrate or non-living material.

Similarly, the concentration of the compound of the invention in the composition (whether for treating surfaces or for coating a fibre, yarn, net, weave) can be varied within a relatively wide concentration range from, for example 0.1 to 70 percent by weight, such as 0.5 to 50 percent by weight, preferably 1 to 40 percent by weight, more preferably 5 to 30 percent by weight, especially 10 to 20 percent by weight.

The concentration shall be chosen according to the field of application such that the requirements concerning insecticidal efficacy, durability and toxicity are met. Adapting the properties of the material can also be accomplished and so custom-tailored textile fabrics are obtainable in this way.

The isocycloseram (Al) when used in the IRS methods of the invention is present on a surface of a dwelling at a coverage of from 0.01 to 2 grams of Al per m2, suitably from 0.05 to 1 grams of Al per m2, preferably from 0.1 to 0.7 grams of Al per m2; in particular, from 100 to 200 mg of Al per m2.

Accordingly an effective amount of isocycloseram can depend on its how its been used, the mosquito against which control is most desired and the environment its been used. Therefore, an effective amount of isocycloseram is sufficient that control of a mosquito is achieved; in case of:
use as IRS formulation, the effective amount is such that coverage of the Al on the surface is from 0.01 to 2 grams of Al per m2, preferably from 0.05 to 1 grams of Al per m2, especially from 0.1 to 0.7 grams of Al per m2, in particular, from 100 to 200 mg of Al per m2;
use incorporated within a net or substrate, the effective amount is 0.05 to 15 percent by weight, preferably 0.2 to 10 percent by weight, more preferably 0.4 to 8 percent by weight, especially 0.5 to 5, such as 1 to 3, percent by weight.

Generally the isocycloseram when used in certain products of the invention is continuously distributed in a thread, yarn, net or weave, but can also be partially or discontinuously distributed in a thread, yarn, net or weave. For example, a net may contain certain parts which are coated or which is made-up of impregnated fibre, and certain other parts which are not; alternatively some of the fibres making up the net is impregnated, or is coated, with the compound of the invention, and some of the other fibres not or these other fibres are impregnated, or are coated, with another insecticide compound (see below).

Nets of the invention impregnated, or coated, with isocycloseram can satisfy the criteria of the WHOPES directive (see “Guidelines for laboratory and field testing of long-lasting insecticidal mosquito nets”, 2005, http://www.who.int/whopes/guidelines/en/) for insecticide-containing long-lasting mosquito nets up to 20 washes only, which means that such nets should not lose their biological activity after just 20 wash cycles or so.

In an embodiment, a net of the invention impregnated, or coated, with isocycloseram can have biological activity in accordance with WHOPES guidelines of a knockdown after 60 minutes of between 95 percent and 100 percent or a mortality after 24 hours of between 80 percent and 100 percent after at least 20, such as 25, preferably at least 30 and even more preferably at least 35 washes.

The “WHOPES directive” is to be understood as meaning the directive “Guidelines for laboratory and field testing of long-lasting insecticidal mosquito nets”, 2005). This directive is retrievable at the following interact address: http://www.who.int/whopes/guidelines/en/.

When a net is “impregnated with” isocycloseram to prepare a net of the present invention, the fibres making up the net are made by melting a polymer, isocycloseram and optionally other compounds, such as other insecticides, additives, stabilisers. When a net is impregnated with such isocycloseram, then the net of the invention contains synthetic fibres; in contrast, a net of the invention coated with such isocycloseram contains synthetic fibres and/or natural fibres.

The polymeric materials useful in the compositions of the invention incorporating isocycloseram can be produced by mixing such isocycloseram with the polymer in the liquid phase, and optionally other additives (such as binders and/or synergists), and other insecticidal compounds.

Methods of making suitable polymeric materials and then processing it are described in the art-see for example, WO09121580, WO2011/141260.

For example, nets based on an isocycloseram insecticide-containing polymeric material are produced by the following steps:
a) melting the polymer to be used and one or more insecticidally active ingredients together or separately at temperatures between 120 and 250 degrees centigrade,
b) forming the melt of step a) into spun threads and cooling,
c) optionally leading the spun threads formed in step b) through a drawing system and drawing and then optionally setting out the threads,
d) knitting the spun threads to form a net,
e) subjecting the net to a heat-setting operation wherein the temperature for the heat-setting operation is chosen to be 20 degrees centigrade below the melting temperature of the polymer to be used.

The heat setting in step e) of the production of the nets is preceded by a washing step. Water and a detergent is preferably used for this. The heat setting is preferably carried out in a dry atmosphere.

Although the manufacture of the nets incorporated with the insecticide compound can occur in a single location, it is also envisaged that the different steps can take place in different locations. So a composition comprising isocycloseram may be made which can then be processed into a polymer. Accordingly, the present invention also provides a composition comprising isocycloseram in a concentrated form, which composition may also contain additives (such as binders and/or synergists), and other insecticidal compound(s) (which composition had been prepared explicitly for making a polymer material impregnated with the isocycloseram (such a composition is often referred to as a “masterbatch”)). The amount of the isocycloseram in the masterbatch would depend on the circumstances, but in general can be 10 to 95 percent by weight, such as 20 to 90 percent by weight, preferably 30 to 85 percent by weight, more preferably 35 to 80 percent by weight, especially 40 to 75 percent by weight.

Also made available in the present invention are compositions or formulations for coating walls, floors and ceilings inside of buildings and for coating a substrate or non-living material, which comprise isocycloseram. The inventive compositions can be prepared using known techniques for the purpose in mind, which could contain a binder to facilitate the binding of the compound to the surface or other substrate. Agents useful for binding are known in the art and tend to be polymeric in form. The type of binder suitable for composition to be applied to a wall surface having particular porosities, binding characteristics would be different to a fibre, yarn, weave or net—a skilled person, based on known teachings, would select a suitable binder.

Typical binders are poly vinyl alcohol, modified starch, poly vinyl acrylate, polyacrylic, polyvinyl acetate co polymer, polyurethane, and modified vegetable oils. Suitable binders can include latex dispersions derived from a wide variety of polymers and co-polymers and combinations thereof. Suitable latexes for use as binders in the inventive compositions comprise polymers and copolymers of styrene, alkyl styrenes, isoprene, butadiene, acrylonitrile lower alkyl acrylates, vinyl chloride, vinylidene chloride, vinyl esters of lower carboxylic acids and alpha, beta-ethylenically unsaturated carboxylic acids, including polymers containing three or more different monomer species copolymerized therein, as well as post-dispersed suspensions of silicones or polyurethanes. Also suitable may be a polytetrafluoroethylene (PTFE) polymer for binding the active ingredient to other surfaces.

The formulation according to the present invention comprises at least one compound listed in Table 1 (or a pesticide (A)), and a carrier, such as water (C), and optionally a polymeric binder or carrier (B) and further components (D).

The polymeric binder binds the isocycloseram to the surface of the non-living material and ensures a long-term effect. Using the binder reduces the elimination of the isocycloseram pesticide out of the non-living material due to environmental effects such as rain or due to human impact on the non-living material such as washing and/or cleaning it. The further components can be an additional insecticide compound, a synergist, a UV stabiliser.

The inventive compositions can be in a number of different forms or formulation types, such as suspensions, capsules suspensions, and a person skilled in the art can prepare the relevant composition based on the properties of the isocycloseram, its uses and also application type.

For example, the isocycloseram used in the methods and other aspects of the present invention may be encapsulated in the formulation. A encapsulated compound can provide improved wash-fastness and also longer period of activity. The formulation can be organic based or aqueous based, preferably aqueous based.

Microencapsulated isocycloseram suitable for use in the compositions and methods according to the invention are prepared with any suitable technique known in the art. For example, various processes for microencapsulating material have been previously developed. These processes can be divided into three categories-physical methods, phase separation and interfacial reaction. In the physical methods category, microcapsule wall material and core particles are physically brought together and the wall material flows around the core particle to form the microcapsule. In the phase separation category, microcapsules are formed by emulsifying or dispersing the core material in an immiscible continuous phase in which the wall material is dissolved and caused to physically separate from the continuous phase, such as by coacervation, and deposit around the core particles. In the interfacial reaction category, microcapsules are formed by emulsifying or dispersing the core material in an immiscible continuous phase and then an interfacial polymerization reaction is caused to take place at the surface of the core particles. The concentration of the isocycloseram present in the microcapsules can vary from 0.1 to 60% by weight of the microcapsule.

The formulation according to the invention may be formed by mixing all ingredients together with water optionally using suitable mixing and/or dispersing aggregates. In general, the formulation is formed at a temperature of from 10 to 70 degrees centigrade, preferably 15 to 50 degrees centigrade, more preferably 20 to 40 degrees centigrade.

It is possible to use a pesticide (A) (i.e., isocycloseram alone or in mixture with other suitable mosquitocides), solid polymer (B) and optionally additional additives (D) and to disperse them in the aqueous component (C).

If a binder is present in a composition of the present invention, it is preferred to use dispersions of the polymeric binder (B) in water as well as aqueous formulations of the pesticide (A) in water which have been separately prepared before. Such separate formulations may contain additional additives for stabilizing (A) and/or (B) in the respective formulations and are commercially available. In a second process step, such raw formulations and optionally additional water (component (C)) are added.

Also combinations are possible, i.e. using a pre-formed dispersion of (A) and/or (B) and mixing it with solid (A) and/or (B).

A dispersion of the polymeric binder (B) may be a pre-manufactured dispersion already made by a chemicals manufacturer.

However, it is also within the scope of the present invention to use “hand-made” dispersions, i.e. dispersions made in small-scale by an end-user. Such dispersions may be made by providing a mixture of about 20 percent of the binder (B) in water, heating the mixture to temperature of 90 to 100 degrees centigrade and intensively stirring the mixture for several hours.

It is possible to manufacture the formulation as a final product so that it can be readily used by the end-user for the process according to the present invention. However, it is of course also possible to manufacture a concentrate, which may be diluted by the end-user with additional water (C) to the desired concentration for use.

In an embodiment, a composition suitable for IRS application or a coating formulation containing isocycloseram contains the active ingredient and a carrier, such as water, and may also one or more co-formulants selected from a dispersant, a wetter, an anti-freeze, a thickener, a preservative, an emulsifier and a binder or sticker.

Furthermore, it may be possible to ship the formulation to the end-user as a kit comprising at least
a first component comprising at least one compound listed in Table 1 (A); and
a second component comprising at least one polymeric binder (B).
Further additives (D) may be a third separate component of the kit, or may be already mixed with components (A) and/or (B).

The end-user may prepare the formulation for use by just adding water (C) to the components of the kit and mixing.

The components of the kit may also be formulations in water. Of course it is possible to combine an aqueous formulation of one of the components with a dry formulation of the other component(s).

As an example, the kit can comprise
one formulation of a compound listed in Table 1 (A) and optionally water (C); and
a second, separate formulation of at least one polymeric binder (B), water as component (C) and optionally components (D).

Accordingly, in a further aspect the present invention provides a kit for treating a fibre, yarn, net and weave by coating wash resistant insecticidal properties thereto comprising: a first sachet comprising a pre-measured amount of at least one compound listed in Table 1, and a second sachet comprising a pre-measured amount of at least one polymeric binder. The resulting treated fibre, yarn, net and weave has imparted thereto the insecticidal properties needed for vector control, such as to control vector-carrying mosquitoes.

The concentrations of the components (A), (B), (C) and optionally (D) will be selected by the skilled artisan depending of the technique to be used for coating/treating.

In general, the amount of pesticide (A) may be up to 50, preferably 5 to 50, such as 10 to 40, especially 15 to 30, percent by weight, based on weight of the composition.

The amount of polymeric binder (B) may be in the range of 0.01 to 30, preferably 0.5 to 15, more preferably 1 to 10, especially 1 to 5, percent by weight, based on weight of the composition.

If present, in general the amount of additional components (D) is from 0.1 to 20, preferably 0.5 to 15, percent by weight, based on weight of the composition. If present, suitable amounts of pigments and/or dyestuffs are in general 0.01 to 5, preferably 0.1 to 3, more preferably 0.2 to 2, percent by weight, based on weight of the composition.

A typical formulation ready for use comprises 0.1 to 40, preferably 1 to 30, percent of components (A), (B), and optionally (D), the residual amount being water (C).

A typical concentration of a concentrate to be diluted by the end-user may comprise 5 to 70, preferably 10 to 60, percent of components (A), (B), and optionally (D), the residual amount being water (C).

The formulation of the present invention may be applied to polymeric material before their formation into the required products, e.g. while still a yarn or in sheet form, or after formation of the relevant products.

For the case of nets and/or weaves, a process for coating nets and/or weaves at least comprising the following steps:
a) treating the nets and/or weaves with the aqueous formulation according to the invention by any of the procedural steps selected from the group of
   (a1) passing the material through the formulation; or
   (a2) contacting the material with a roller that is partly or fully dipped into the formulation and drawing the formulation to the side of the material in contact with the roller, or
   (a3) submerging the material into the formulation; or
   (a4) spraying the formulation onto the material; or
   (a5) brushing the formulation onto or into the material; or
   (a6) applying the formulation as a foam; or
   (a7) coating the formulation onto material.
b) optionally removing surplus formulation by squeezing the material between rollers or by means of a doctor blade; and
c) drying the material.

In case the raw materials containing residues of preceding production processes, e.g. sizes, spin finishes, other auxiliaries and/or impurities, it may be beneficial to perform a washing step before the coating.

Specifically, the following details are important for the steps a), b), and c).

### Step a1)

The formulation is applied by passing the material through the aqueous formulation. Said step is known by a person skilled in the art as padding. In a preferred embodiment the material is completely submerged in the aqueous formulation either in a trough containing the liquor or the material is passed through the formulation which is held between two horizontally oriented rollers. In accordance with the invention, the material may either be passed through the formulation or the formulation may be passed through the material. The amount of uptake of the formulation will be influenced by the stability of concentrated baths, the need for level distribution, the density of material and the wish to save energy costs for drying and curing steps. Usual liquor-uptakes may be 40 to 150 percent on the weight of material. A person skilled in the art is familiar with determining the optimum value. Step a1) is preferred for coating open-width material which is later tailored into nets.

For small-scale production or re-coating of non-treated nets, use of a simple hand-held roller may be sufficient.

### Step a2)

It is further possible to apply the aqueous formulation on the material by a roller that is partly dipped into the dispersion thus applying the dispersion to the side of the material in contact with the roller (kiss-rolling). By this method it is possible to coat only one side of the material which is advantageous if e.g. direct contact of the human skin with insecticide-treated material is to be avoided.

Coating of the material in step a1), a2) or a3) is typically carried out at temperatures from 10 to 70 degrees centigrade, preferably 15 to 50 degrees centigrade, more preferably 20 to 40 degrees centigrade

### Step a4)

The spray may be applied in continuous processes or in batch-wise processes in suitable textile machines equipped with a spraying device, e.g. in open-pocket garment washer/extractors. Such equipment is especially suitable for impregnating ready-made nets.

### Step a6)

A foam comprises less water than the dispersion mentioned above. The drying process may therefore be very short. The treatment may be performed by injecting gas or blends of gas (e.g., air) into it. The addition of surfactants, preferably with film-forming properties, may be required. Suitable surfactants and the required technical equipment are known to persons skilled in the art.

### Step a7)

A coating process may preferably carried out in a doctor-blade process. The process conditions are known to a person skilled in the art.

### Step b)

The surplus emulsion is usually removed by squeezing the material, preferably by passing the material through rollers as known in the art thus achieving a defined liquor uptake. The squeezed-off liquor may be re-used. Alternatively, the surplus aqueous emulsion or aqueous dispersion may be removed by centrifuging or vacuum suction.

### Step c)

Drying may be performed at ambient temperatures. In particular, such a passive drying may be carried out in hot-dry climate. Of course, the drying process may be accelerated applying elevated temperatures. An active drying process would normally be performed during high scale processing. The drying is in general carried out temperatures below 200 degrees centigrade Preferred temperatures are from 30 to 170 degrees centigrade, more preferably at room temperature. The temperature choice is determined by the thermal stability of the insecticide in the formulation and the thermal stability of the non-living material impregnated.

For the method according to the invention aqueous formulation comprising at least one pigment and/or at least one dyestuff may be used so that the material is not only coated with the isocycloseram pesticide but in addition also coloured at the same time.

In a further aspect, the present invention provides a method for treating a fibre, yarn, net and weave by coating wash resistant insecticidal properties thereto comprising (i) preparing a treatment composition, which comprises at least one compound listed in Table 1, (ii) treating said fibre, yarn, net and weave and (iii) drying the resulting treated a fibre, yarn, net and weave.

The polymeric binder (B) can be dispersed in an aqueous formulation and comprises one or more fluorinated acrylic copolymers useful in the water and oil resistant formulations includes copolymer prepared by the polymerization of a perfluoroalkyl acrylate monomer and a comonomer, especially an acrylate monomer. The binder may also be fluorocarbon resins (as described in WO 2006/128870.

Only water is used as solvent for the formulation. However, trace amounts of organic solvents miscible with water may be present. Examples of solvents comprise water-miscible alcohols, e.g. monoalcohols such as methanol, ethanol or propanol, higher alcohols such as ethylene glycol or polyether polyols and ether alcohols such as butyl glycol or methoxypropanol. Preferably the content of an organic solvent is no more than 5 percent by weight (based on component (C), more preferably no more than 1 percent by weight (based on component (C), in particular no more than 0.1 percent by weight, based on component (C).

Depending on the intended use of the non-living material to be treated the formulation according to the present invention may further comprise one or more components or additives (D) selected from preservatives, detergents, fillers, impact modifiers, anti-fogging agents, blowing agents, clarifiers, nucleating agents, coupling agents, fixative agents, cross-linking agents, conductivity-enhancing agents (antistats), stabilizers such as antioxidants, carbon and oxygen radical scavengers and peroxide decomposing agents and the like, flame retardants, mould release agents, agents having UV protecting properties, spreading agents, anti-blocking agents, anti-migrating agents, foam-forming agents, anti-soiling agents, thickeners, further biocides, wetting agents, plasticizers and film-forming agents, adhesive or anti-adhesive agents, optical brightening (fluorescent whitening) agents, pigments and dyestuffs.

A typical amount of the polymeric binder (B) is from 0.01 to 10 percent by weight (dry weight) of the (dry) weight of the material. As a general guideline, the weight ratio between insecticide and binder (B) should approximately be constant with a value depending on the insecticidal and migratory ability of the insecticide, i.e. the higher the amount the insecticide the higher also the amount of binder (B). Preferred amounts of binder (B) are from 0.1 to 5 percent by weight, more preferably 0.2 to 3 percent by weight of the (dry) weight of the material.

The coated material can comprise at least one pigment and/or at least one dyestuff. The amount of the at least one pigment and/or dyestuff is in general from 0.05 to 10 percent by weight, preferably 0.1 to 5 percent by weight, more preferably 0.2 to 3.5 percent by weight of the (dry) weight of the material.

The method of coating or treating the non-living material is not limited to a specific technology. Coating may be performed by dipping or submerging the non-living substrate into the formulation or by spraying the formulation onto the surface of the non-living material. After treating the treated non-living substrate may be dried simply at ambient temperatures.

Accordingly, no sophisticated technology is necessary for the coating, and therefore the coating process may be carried out by the end-user itself in at low-scale.

For instance, a typical end-user may coat/treat a net itself, e.g. within its household, using the formulation according to the present invention. For this purpose, it is in particular advantageous to use a kit as herein defined.

In an embodiment, the present invention provides a polymer, a fibre, a thread, a yarn, a net or weave comprising one or more compounds of the invention (listed in Table 1), where also incorporated can be one or more other customary materials used to make such a polymer, and the polymer, a fibre, a thread, a yarn, a net or weave optionally can further incorporate one or more other insecticides and/or synergists.

In an embodiment, the present invention provides a net or weave incorporated with one or more isocycloseram (listed in Table 1), which optionally further incorporates one or more other insecticides and/or synergists.

As described in the art, the isocycloseram useful in the methods and other aspects of the present invention can be used alone or in combination with another insecticide, synergist, insect repellent, chemosterilant, flame retardant, UV protector/absorber, and/or additives for controlling release characteristics.

When used in accordance with the invention, the isocycloseram may be used alone to control a mosquito or used in combination with one or other known insecticides and/or one or more additives (such as synergists)—in polymers for making non-living substrates, such as nets and weaves, for formulations for treating non-living substrates, such as nets and weaves, in IRS products and space-spraying products.

In an embodiment, the present invention provides a composition (useful for coating a polymeric material or a product therefrom, or a useful as a spray product) comprising one or more compounds of the invention, which optionally further comprises one or more other insecticide and/or synergists and one or more other additives.

Examples of synergists are piperonylbutoxide (PBO), sebacic esters, fatty acids, fatty acid esters, vegetable oils, esters of vegetable oils, alcohol alkoxylates and antioxidants.

Suitable sebacic esters are for example dimethyl sebacate, diethyl sebacate, dibutyl sebacate, dibenzyl sebacate, bis(N-succinimidyl) sebacate, bis(2-ethylhexyl) sebacate, bis(1-octyloxy-2,2,6,6-tetramethyl-4-piperidyl) sebacate, bis(2,2,6,6-tetramethyl-4-piperidyl) sebacate and bis(1,2,2,6,6-pentamethyl-4-piperidinyl) sebacate (BLS292).

Suitable fatty acids are (preferably mono- or polyunsaturated) fatty acids having a chain length of 12 to 24 carbon atoms, for example palmitoleic acid, oleic acid, elaidic acid, vaccenic acid, icosenic acid, cetoleic acid, erucic acid, nervonic acid, linoleic acid, alpha-linolenic acid, gamma-linolenic acid, arachidonic acid, timnodonic acid, clupanodonic acid and cervonic acid. Particular preference is given to oleic acid, linoleic acid, alpha-linolenic acid and gamma-linolenic acid.

Suitable fatty acid esters are preferably methyl or ethyl esters of the above-recited fatty acids. Methyl esters are particularly preferred. Fatty acids and their esters can each also be present in mixtures.

Useful vegetable oils include all plant-derivable oils customarily usable in agrochemical compositions. As examples there may be mentioned sunflower oil, rapeseed oil, olive oil, castor oil, colza oil, maize kernel oil, cottonseed oil and soybean oil. Rapeseed oil is preferred.

Suitable esters of vegetable oils are methyl or ethyl esters of the above-recited oils. Methyl esters are preferred.

Antioxidants useful as additives include for example butylhydroxytoluene, butylhydroxyanisole and L-ascorbic acid.

Plant essential oils may also be used in an indoor residual spray compositions; examples are those selected from citronella, peppermint oil, d-limonene and abies sibirica. These plant essential oil materials are known and used for other uses and can be prepared by a skilled artisan by employing known methods and also are available commercially.

In addition to isocycloseram, the methods, compositions, polymer, product, substrate and/or integrated mosquito management solution according to the invention may contain one or more further insecticidally active ingredients. Particularly examples are one or more active ingredients from the class of organophosphates, pyrethroids, carbamates or neonicotinoid, and also DDT, indoxacarb, nicotine, bensultap, cartap, spinosad, camphechlor, chlordane, endosulfan, gamma-HCH, HCH, heptachlor, lindane, methoxychlor, acetoprole, ethiprole, fipronil, pyrafluprole, pyriprole, vaniliprole, avermectin, emamectin, emamectin-benzoate, ivermectin, milbemycin, diofenolan, epofenonane, fenoxycarb, hydroprene, kinoprene, methoprene, pyriproxifen, triprene, chromafenozide, halofenozide, methoxyfenozide, tebufenozide, bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron, buprofezin, cyromazine, diafenthiuron, azocyclotin, cyhexatin, fenbutatin-oxide, chlorfenapyr, binapacyrl, dinobuton, dinocap, DNOC, fenazaquin, fenpyroximate, pyrimidifen, pyridaben, tebufenpyrad, tolfenpyrad, hydramethylnon, dicofol, rotenone, acequinocyl, fluacrypyrim, Bacillus thuringiensis strains, spirodiclofen, spiromesifen, spirotetramat, 3-(2,5-dimethylphenyl)-8-methoxy-2-oxo-1-azaspiro[4.5]dec-3-en-4-yl ethyl carbonate (alias: carbonic acid, 3-(2,5-dimethylphenyl)-8-methoxy-2-oxo-1-azaspiro[4.5]dec-3-en-4-yl ethyl ester, CAS-Reg.-No.: 382608-10-8), flonicamid, amitraz, propargite, flubendiamide, chloranthraniliprol, thiocyclam hydrogen oxalate, thiosultap-sodium, azadirachtin, Bacillus spec., Beauveria spec., Metarrhizium spec., Paecilomyces spec., Thuringiensin, Verticillium spec., aluminium phosphid, methylbromide, sulfurylfluorid, cryolite, flonicamid, pymetrozine, clofentezine, etoxazole, hexythiazox, amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonylbutoxid, kaliumoleat, pyridalyl, sulfluramid, tetradifon, tetrasul, triarathene and verbutin.

In a further aspect, the present invention provides a method for protecting a mammal, including a human, against mosquitoes, the method comprising applying to the mosquito or to a locus of potential or known interaction between the mammal and the mosquito, a vector control solution comprising a mosquitocidally effective amount of a compound selected from the group consisting of isocycloseram.

Another aspect of the invention is a method for controlling the spread of a vector-borne disease, comprising: identifying an mosquito vector; and contacting the mosquito vector or its environment with a vector control solution comprising a mosquitocidally effective amount of a compound selected from the group consisting of isocycloseram.

An aspect of the invention also includes a mosquitocidal method which comprises contacting a mosquito or its environment with a vector control solution comprising an mosquitocidally effective amount of a compound selected from the group consisting of isocycloseram.

The present invention also provides a method, comprising: (i) identifying a locus of potential or known interaction between a mosquito vector and a mammal, including a human, susceptible to pathogenic disease infection when contacted by such vector and (ii) positioning a vector control solution at the locus, wherein the solution includes a mosquitocidally effective amount of a compound selected from the group consisting of isocycloseram.

The present invention through control of mosquitos would also be expected to control the many viruses carried by such vectors. As an example, control of the mosquitos of the genus Aedes by use of one or more of the defined compounds Table 1, as part of a vector control solution, may control the Zika infections. Examples of mosquitos reported to spread the Zika virus are the Aedes mosquitoes, such as Aedes aegypti and Aedes albopictus. Accordingly, in an aspect, the present invention provide a method of controlling Zika virus infection, wherein one or more of the defined compounds Table 1 is present in a mosquitocidally effective amount in the vicinity of Aedes mosquitoes, such as Aedes aegypti and Aedes albopictus. In the vicinity of the mosquitoes is meant areas where mosquitos are likely to be present, such as in the environment in general, specifically in a room, or at the site of a mosquito biting an individual or mammal, for example, on the skin surface.

In each of the methods according to present invention, the vector control solution is preferably one or more of a composition, a product and a treated article, each comprising a compound selected from the group consisting of isocycloseram.

A “fibre” as used in the present invention refers only to a fine, threadlike piece, generally made of natural material, such as cotton, or jute.

In each aspect and embodiment of the invention, “consisting essentially” and inflections thereof are a preferred embodiment of “comprising” and its inflections, and “consisting of” and inflections thereof are a preferred embodiment of “consisting essentially of” and its inflections.

The disclosure in the present application makes available each and every combination of embodiments disclosed herein.

The following Examples serve to illustrate the invention. They do not limit the invention.

### BIOLOGY EXAMPLES

### Examples B1-B3: Bottle Assay Based on the Guideline for Evaluating Insecticide Resistance in Vectors Using the CDC Bottle Bioassay

1 ml of acetone containing a test compound at a defined concentration, and 1500 ppm Mero (Bayer Crop Science) was added to a 250 ml glass bottle, the bottle was placed on a rolling table to coat the inner surfaces as the solvent evaporated. Once dry, approximately twenty five non-blood fed adult female mosquitoes of the appropriate species and strains (each two or three days old) were aspirated from the stock culture and gently blown into the exposure bottle. The lid of the bottle was replaced, and the bottle placed upright out of direct sun light under standard culture conditions, nominally 28° C. and 60-80% relative humidity.

A stopwatch was started, and the assessment of the knock-down were made after 60 minutes. A mosquito was said to be knocked down if it was unable to stand, following the CDC definition.

After one hour the mosquitoes were carefully removed from the bottle with an aspirator and placed in a recovery cup. The mosquitoes were supplied with a 10% sucrose solution on a cotton wool bung, and stored under culture conditions. Assessments of the mortality were made after 24 and 48 hours.

Each treatment was replicated a minimum of three times, with the mean knockdown or mortality recorded. In each study, a set of bottles was infested with a known insecticide susceptible strain of mosquitoes from the same genera as the resistant strains. Results are shown in Tables B1-B3.

TABLE B1

| | Species and strain | | | | | |
|---|---|---|---|---|---|---|
| | Anopheles | | An. gambiae | | An. gambiae | |
| | stephensi | | Tiassale | | Kisumu | |
| | Pyrethroid resistance status | | | | | |
| | Susceptible | | Resistant | | Susceptible | |
| | Mean % mortality | | Mean % mortality | | Mean % mortality | |
| | 60 | 24 | 60 | 24 | 60 | 24 |
| Treatment | minutes | hours | minutes | hours | minutes | hours |
| 25 μg/bottle Isocycloseram + 1.5 | 12 | 70.4 | 38.4 | 89.6 | 56.8 | 89.6 |
| mg Mero | | | | | | |
| 50 μg/bottle Isocycloseram + 1.5 | 60.8 | 98.4 | 84 | 100 | 88.8 | 100 |
| mg Mero | | | | | | |
| 250 μg/bottle Isocycloseram + 1.5 | 79.2 | 100 | 98.4 | 100 | 99.2 | 100 |
| mg Mero | | | | | | |
| 20 μg/bottle Permethrin | 100 | 100 | 45.6 | 80 | 100 | 100 |
| 1.5 mg/bottle Mero | 0 | 1.6 | 0 | 2.4 | 0 | 3.2 |
| Control | 0 | 0.8 | 0 | 0.8 | 0 | 2.4 |

TABLE B2

| | Species and strain | | | | | |
|---|---|---|---|---|---|---|
| | An. gambiae | | An. gambiae | | An. gambiae | |
| | Kisumu | | KisKDR | | M'Bé | |
| | Pyrethroid resistance status | | | | | |
| | Susceptible | | Resistant | | Resistant | |
| | Mean % mortality | | Mean % mortality | | Mean % mortality | |
| | 60 | 24 | 60 | 24 | 60 | 24 |
| Treatment | minutes | hours | minutes | hours | minutes | hours |
| 50 μg/bottle Isocycloseram + 1.5 | 80.77 | 100 | 86.7 | 100 | 37.8 | 70.3 |
| mg Mero | | | | | | |
| 250 μg/bottle Isocycloseram + 1.5 | 80.77 | 100 | 100 | 100 | 89.3 | 100 |
| mg Mero | | | | | | |
| 20 μg/bottle Permethrin | 100 | 100 | 100 | 82.1 | 12.5 | 13.9 |
| 1.5 mg/bottle Mero | 32.89 | 21.05 | 11.8 | 18.4 | 0 | 1.4 |
| Control | 0 | 1.3 | 0 | 1.4 | 0 | 0 |

TABLE B3

| | Species and strain | | | |
|---|---|---|---|---|
| | An. gambiae Kisumu | | An. gambiae Tiassale | |
| | Pyrethroid resistance status | | | |
| | Susceptible | | Resistant | |
| | Mean % mortality | | Mean % mortality | |
| | 60 | | 60 | |
| Treatment | minutes | 24 hours | minutes | 24 hours |
| 25 μg/bottle Isocycloseram + 1.5 mg Mero | 98.8 | 100 | 96.9 | 100 |
| 50 μg/bottle Isocycloseram + 1.5 mg Mero | 96.4 | 100 | 99.2 | 100 |
| 250 μg/bottle Isocycloseram + 1.5 mg | 99.2 | 100 | 99.1 | 100 |
| Mero | | | | |
| 20 μg/bottle Permethrin | 100 | 100 | 99.1 | 91.7 |
| 1.5 mg/bottle Mero | 9.4 | 3.3 | 4.8 | 4.8 |

1. Use of isocycloseram in mosquito insect control.

2. Use of isocycloseram in control of mosquito insects that are disease vectors.

3. Use of isocycloseram in control of mosquito insects that are malaria vectors.

4. The use of isocycloseram according to claim 1 wherein the mosquito is an insecticide resistant mosquito.

5. The use of isocycloseram according to claim 1 wherein the mosquito is a pyrethroid insecticide resistant mosquito.

6. The use of isocycloseram according to claim 1 wherein the mosquito is selected from the genus Anopheles, Culex and Aedes.

7. The use of isocycloseram according to claim 1 wherein the mosquito is selected from Aedes aegypti, Aedes albopictus, Aedes japonicas, Aedes vexans, Culex molestus, Culex pallens, Culex pipiens, Culex quinquefasciatus, Culex restuans, Culex tarsalis, Anopheles albimanus, Anopheles arabiensis, Anopheles coluzzii, Anopheles darlingi, Anopheles dirus, Anopheles funestus, Anopheles gambiae s.l., Anopheles gambiae s.s. (Ifakara Strain), An. gambiae Tiassale; An. gambiae Kisumu, An. gambiae KisKDR, An. gambiae M'Bé, Anopheles melas, Anopheles minimus, Anopheles sinensis, Anopheles stephensi, and Mansonia titillans.

8. A method of preparing a polymeric material impregnated with isocycloseram, which material is useful for making substrate or non-living material, such as threads, fibres, yarns, pellets, nets and weaves, which method comprises mixing a polymer with isocycloseram at a temperature between 120 to 250° C.

9. A method for controlling nuisance, disease carrying or pyrethroid resistant mosquito insect pests comprising applying mosquitocidally effective amount of isocycloseram to such mosquito pest or to a locus where such control is desired.

10. A method according to claim 9 for mosquito insect-control which comprises (a) applying an effective amount of a liquid composition comprising isocycloseram, and optionally, a polymeric binder or carrier, one or more other insecticides, and/or synergists, to a surface of a dwelling; and/or (b) placing a substrate or non-living material incorporated with isosycloseram, and optionally an additive, one or more other insecticides, and/or synergists, within a dwelling.

11. The method according to claim 1 wherein the mosquito insect is a disease vector.

12. The method according to claim 1 wherein the mosquito insect is a malaria vector.

13. The method according to claim 1 wherein the mosquito insect is an insecticide resistant mosquito.

14. The method according to claim 1 wherein the mosquito insect is a pyrethroid insecticide resistant mosquito.

15. The method according to claim 1 wherein the mosquito insect is selected from the genus Anopheles, Culex and Aedes.

16. The method according to claim 1 wherein the mosquito insect is selected from Aedes aegypti, Aedes albopictus, Aedes japonicas, Aedes vexans, Culex molestus, Culex pallens, Culex pipiens, Culex quinquefasciatus, Culex restuans, Culex tarsalis, Anopheles albimanus, Anopheles arabiensis, Anopheles coluzzii, Anopheles darlingi, Anopheles dirus, Anopheles funestus, Anopheles gambiae s.l., Anopheles gambiae s.s. (Ifakara Strain), An. gambiae Tiassale; An. gambiae Kisumu, An. gambiae KisKDR, An. gambiae M'Bé, Anopheles melas, Anopheles minimus, Anopheles sinensis, Anopheles stephensi, and Mansonia titillans.

17. A net incorporated with isocycloseram having a biological activity in accordance with the WHOPES guidelines of a knockdown after 60 minutes of between 95 percent and 100 percent and/or a mortality after 24 hours of between 80 percent and 100 percent after 20 washes.
